(19) United States
(12) Patent Application Publication
(10) Pub. No.: US 2018/0293621 A1
(43) Pub. Date: Oct. 11, 2018

(54) OPTIMIZATION OF REDEEMABLE OFFERS BASED ON USER AVAILABLE CALENDAR DATES

(71) Applicant: International Business Machines Corporation, Armonk, NY (US)

(72) Inventors: Jana H. Jenkins, Raleigh, NC (US); Marylin A. Lincoln, Wake Forest, NC (US); Anuradha Ramamoorthy, Cary, NC (US); Hiroko Takamiya, Chapel Hill, NC (US)

(21) Appl. No.: 15/480,908

(22) Filed: Apr. 6, 2017

(51) Int. Cl. G06Q 30/02; G06Q 10/10

(52) U.S. Cl. CPC G06Q 30/0264; G06K 19/06028; G06Q 30/0235; G06Q 10/1095

(57) ABSTRACT

The present disclosure provides an optimization of redeemable offers for a user based on the user's available calendar days. The user selects a target venue via an application on a mobile device and the application retrieves redeemable offers associated with the selected venue including general redeemable offers and redeemable offers that are specific or unique to the user. The application determines a list of calendar days during which the user is available to use redeemable offers and at least one of the redeemable offers is active. An optimized combination of redeemable offers for each calendar day in the list may be presented the user based on the active redeemable offers and user availability. The list of calendar days may also be added to the user's calendar and a single bar code may be generated for applying the redeemable offers.

### BACKGROUND

The present disclosure relates to improvements in the systems and method used to present a user with optimized redeemable offers based on the user's available calendar dates.

### BRIEF SUMMARY

In an aspect of the present disclosure, a method is disclosed including receiving, via an input device associated with a computing device of a user, a selection of a target venue by the user. The method further includes receiving notification data associated with the target venue. The notification data includes a plurality of redeemable offers of the venue that are available to the user. The method further includes determining, based on the notification data, event calendar days during which the redeemable offers are active. The method further includes receiving calendar data associated with the user. The calendar data includes at least one period of time in which the user is available to use redeemable offers. The method further includes comparing the determined event calendar days of the redeemable offers to the at least one period of time in which the user is available to use redeemable offers and determining, based on the comparison, a list of calendar days during which the user is available to use redeemable offers and at least one of the redeemable offers is active. The method further includes determining an order for the list of calendar days based on the redeemable offers that are active for each calendar day in the list, and presenting the ordered list of calendar days to the user via a display of the computing device.

In aspects of the present disclosure, apparatus, systems, and computer program products in accordance with the above aspect may also be provided. Any of the above aspects may be combined without departing from the scope of the present disclosure.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is a system diagram illustrating a system for recommending optimal shopping days in accordance with an aspect of the present disclosure.

FIG. 2 is a graphical user interface according to an aspect of the present disclosure.

FIGS. 3A and 3B illustrate a flow chart of a method for recommending optimal shopping days according to an aspect of the present disclosure.

FIG. 4 is an exemplary block diagram of a computer system in which processes involved in the system, method, and computer program product described herein may be implemented.

### DETAILED DESCRIPTION

The retail industry employs a variety of methods in order to entice users to purchase their goods or services. In some aspects, the user may receive a redeemable offer notification about coupons, sales, events, rebates, or other similar methods of promoting a product or venue through a variety of communication mediums.

In some aspects, for example, a venue, e.g., a retailer, store, business, or other similar entity that sells products to users, may promote a product by publishing coupons, sales, rewards, rebates, or other events for the product in a tangible medium, e.g., a flyer, store circular, newspaper, signage, billboards, or other similar tangible medium. In some aspects, for example, the venue promote the product by publishing coupons, sales, rewards, rebates, or other events for the product digitally, e.g., on a store web site or social media page, via social media messaging, via text messages, via an application installed on a computing device, via e-mail, via other advertising services such as television or radio, or in other similar manners.

In some aspects, each individual user may also receive targeted promotions from the venue for a product that are specific to that individual user. For example, a user that has certain interests or has viewed a certain product may receive a coupon, sale, reward, event, or other from the venue while another user that has different interests or has not viewed the product may not receive the same redeemable offer.

As technology continues to increase a venue's access to the user, the user has likewise received an increased volume of redeemable offer materials. Where once store circulars, newspapers, and TV advertisements were the norm for redeemable offer communications, users are now bombarded with a plethora of digital advertising campaigns that fill their e-mail inboxes, overload their senses, or otherwise overwhelm the user's ability to sort through all of the promotions that are actually relevant to them. Simply reading through all of these promotions may be time consuming for the user. Making comparisons between the various redeemable offers in the context of the identifying the best deals that match with a user's available calendar days to shop for the product or products in questions may be near impossible for a user.

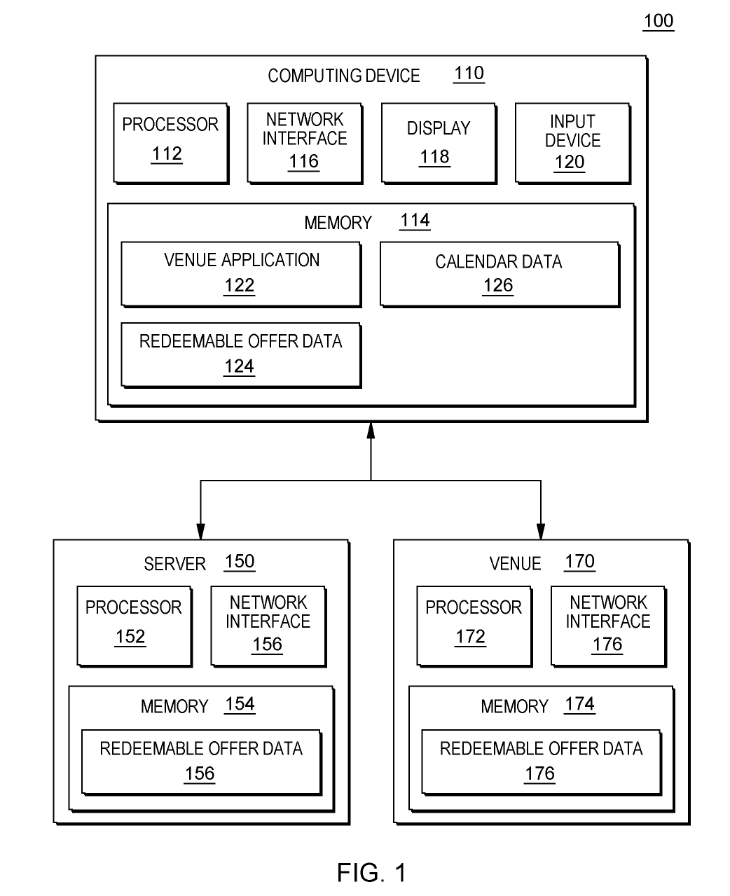

With reference now to FIG. 1, in some aspects, the present disclosure provides a system 100 that may be used to synthesize a selection of optimal shopping days for purchasing products for which a user has received redeemable offers based on the users shopping availability and data associated with the redeemable offers. In some aspects, system 100 includes a computing device 110, a server 150, and venues 170.

Computing device 110 includes at least one processor 112, memory 114, at least one network interface 116, a display 118, an input device 120, and may include any other features commonly found in a computing device. In some aspects, computing device 110 may, for example, be a computing device associated with a user that is configured to present the user with one or more calendar days that are optimal for shopping. In some aspects, computing device 110 may include, for example, a personal computer, laptop, tablet, smart device, smart phone, smart watch, or any other similar computing device that may be used by a user.

Processor 112 may include, for example, a microcontroller, Field Programmable Gate Array (FPGAs), or any other processor that is configured to perform various operations. Processor 112 may be configured to execute instructions as described below. These instructions may be stored, for example, in memory 114.

Memory 114 may include, for example, non-transitory computer readable media in the form of volatile memory, such as random access memory (RAM) and/or cache memory or others. Memory 114 may include, for example, other removable/non-removable, volatile/non-volatile storage media. By way of non-limiting examples only, memory 114 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 116 is configured to transmit and receive data or information to and from a server 150 or any other computing device via wired or wireless connections. For example, network interface 116 may utilize wireless technologies and communication protocols such as Bluetooth®, WWI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 110 to transmit or receive information to or from server 150.

Display 118 may include any display device that is configured to display information to a user of computing device 110. For example, in some aspects, display 118 may include a computer monitor, television, smart television, or other similar displays. In some aspects, display 118 may be integrated into or associated with computing device 110, for example, as a display of a laptop, smart phone, smart watch, or other smart wearable devices, as a virtual reality headset associated with computing device 110, or any other mechanism for displaying information to a user. In some aspects, display 118 may include, for example, a liquid crystal display (LCD), an e-paper/e-ink display, an organic LED (OLED) display, or other similar display technologies. In some aspects, display 118 may be touch-sensitive and may also function as an input device 120.

Input device 120 may include, for example, a keyboard, a mouse, a touch-sensitive display 118, a keypad, a microphone, or other similar input devices or any other input devices that may be used alone or together to provide a user with the capability to interact with computing device 110.

Server 150 includes a processor 152, memory 154, and a network interface 156 that may include similar functionality as processor 112, memory 114, and network interface 116. In some aspects, server 150 may, for example, be any computing device, server, or similar system that is configured to interact with or provide data to computing device 110.

Venue 170 may include any websites, databases, or other data sources related to a venue that may be accessed by server 150 or computing device 110 to gather notification data associated with products of the venue. For example, venue 170 may include an e-commerce website of the venue, a redeemable offers database of the venue 170, or any other site or system associated with the venue 170 that may be accessed to gather sales information including redeemable coupons, redeemable awards, special redeemable codes, information on sales events, credit card related promotions, store card related promotions, user rewards related promotions, rebates, or other similar redeemable offer related data. In some aspects, venue 170 may include a processor 172, memory 174, and a network interface 176 that may include similar functionality as processor 112, memory 114, and network interface 116. In some aspects, memory 174 may store the notification data associated with the venue.

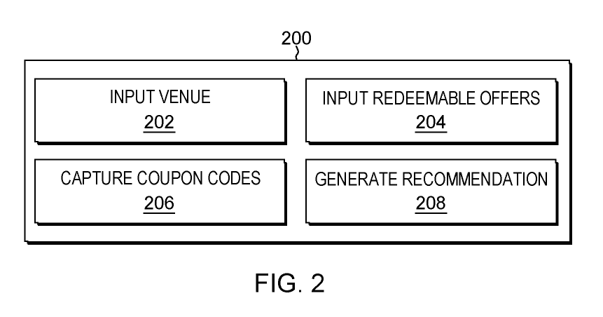

With reference to FIGS. 1 and 2, in some aspects, an application 122 may be installed on computing device 110, for example, in memory 114. Application 122 may be configured for execution by processor 112 to present a user with a graphical user interface (GUI) 200 via display 118. In some aspects, GUI 200 may include an element 202 that may be activated by the user via input device 120 to input a target venue. In some aspects, GUI 200 may include an element 204 that may be activated by the user via input device 120 to input redeemable offers. In some aspects, GUI 200 may include an element 206 that may be activated by the user via input device 120 to capture coupon codes from tangible redeemable offers, e.g., via an input device such as a camera, bar code reader, quick response (QR) code reader, or other similar input devices. Additional elements may also be presented and activatable by the user to input any other materials related to redeemable offers into the application 122, or to perform other similar functions. In some aspects, the user may activate element 204 to input more than one target venue at a time. In some aspects GUI 200 may include an element 208 that is activatable by the user via input device 120 to cause application 122 to generate and present to the user a recommendation list including optimal calendar days and corresponding combinations of redeemable offers that provide the user with an optimal shopping experience.

In some aspects, redeemable offers may be provided to or associated with the user in a variety of ways. For example, the user may receive coupons or other redeemable offers in the mail as a tangible coupon, receive redeemable offers via e-mail or another electronic medium, receive redeemable offers by visiting a web site associated with a venue, or in any other manner. The received redeemable offers may identify a particular product or set of products to which the redeemable offer applies and provide a redeemable offer for the product such as a percentage discount, dollar value discount, or other offer. In some aspects, the coupon may include a coupon code, e.g., a bar code, QR code, or other scan-able feature, that may be scanned by a store at checkout, by the computing device 110, or in any other manner to apply the coupon to a purchase.

In some aspects the user may activate element 206 to scan, capture, or otherwise associate coupon codes received from tangible redeemable offers with application 122 for later use by the user. In some aspects, for example, a user may scan coupons or other redeemable offers using input device 120, e.g., a scanner, camera or other similar component of computing device 110. The scanned coupon or redeemable offer may be stored in memory 114 as redeemable offer data 124. In some aspects, some or all of the redeemable offers provided to the user in a tangible medium may be redeemable offers that have been specifically offered or targeted to the user and not to all members of the general public.

In some aspects, server 150 may store redeemable offer data 156 in memory 154. For example, any redeemable offers that have been digitally associated with the user, e.g., via e-mail, social media, or in any other manner, may be stored or associated with the user as redeemable offer data 156 on server 150. In some aspects, redeemable offers that have been digitally associated with the user may be general redeemable offers that are also available to the general public. In some aspects, some or all of the redeemable offers that have been digitally associated with the user may be redeemable offers that have been specifically offered or targeted to the user and not to all members of the general public. In some aspects, computing device 110 may store redeemable offer data 156 directly in memory 114 without the need for a separate server 150 to store the redeemable offer data 156.

In some aspects, computing device 110 or server 150 may access venue 170, e.g., web sites or databases associated with a venue, to gather redeemable offers for that venue. For example, venue 170 may store redeemable offers in memory 174 as redeemable offer data 176. Redeemable offer data 176 may include redeemable offers published on web pages, digital newspapers, advertisements, or any other redeemable offers. In some aspects, redeemable offer data 176 may include redeemable offers that are offered to the general public.

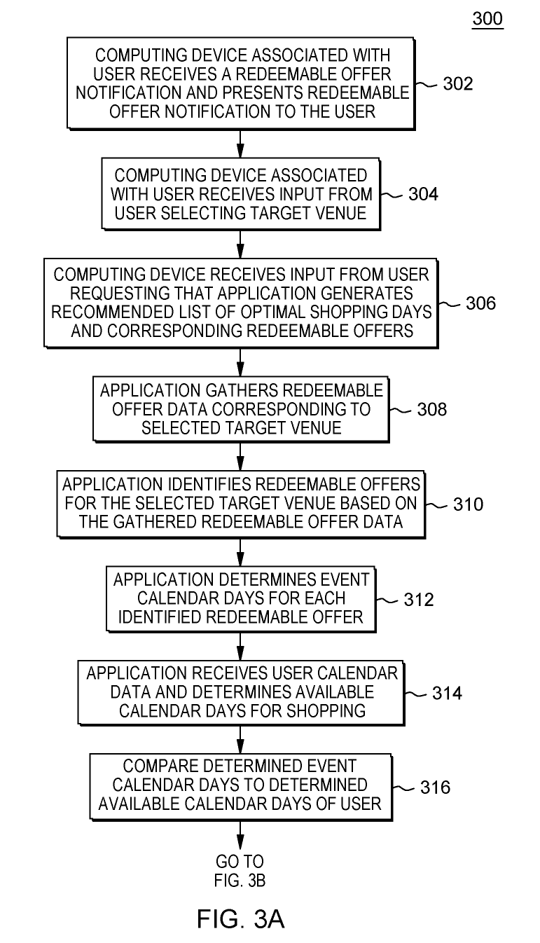

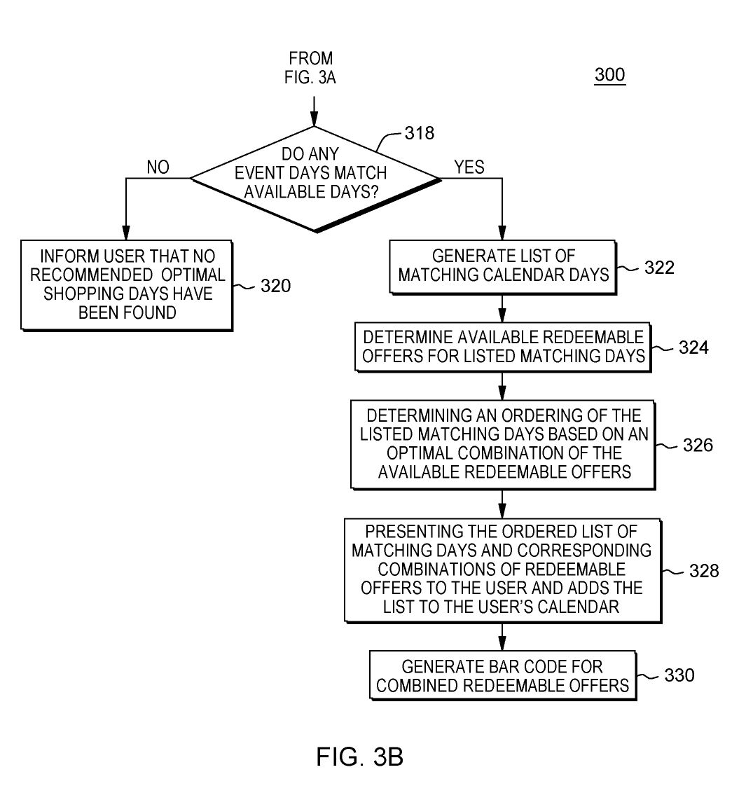

With reference now to FIGS. 3A and 3B, a method 300 for providing a user with a list of optimal days for shopping is illustrated.

At 302, a redeemable offer notification is transmitted, for example, by server 150 or venue 170, to the computing device 110 of the user. Computing device 110 of the user receives the redeemable offer notification and presents the redeemable offer notification to the user, e.g., via display 118. For example, the computing device 110 of the user may receive a notification that a venue is holding a sale during a specified period of time, e.g., during specified calendar days during the next week.

In some aspects, the redeemable offer notification may be received by the user at a mailing address associated with the user as a tangible redeemable offer such as, for example, a circular, newspaper, or other similar tangible item containing redeemable offers for a venue. For example, the user may activate application 122 on computing device 110 and may scan such a tangible redeemable offer into application 122 by activating element 206 (FIG. 2), e.g., by scanning a coupon code found on or associated with the tangible redeemable offer. In some aspects, the scanned tangible redeemable offer may be stored as redeemable offer data 124 in memory 114 of a computing device 110 associated with the user. In some aspects, the redeemable offer data 124 may be transmitted by computing device 110 to server 150 for storage as redeemable offer data 156. In some aspects, the user may have a user account on server 150 and the redeemable offer data 156 may be associated with the user's user account.

In some aspects, the redeemable offer notification may be a digital redeemable offer such as, for example, an e-mail, notification, pop-up, or other similar digital offers that is transmitted to the computing device 110 for presentation to the user, e.g., by server 150, venue 170, a mail server, or any other system associated with venue 170. In some aspects, for example, application 122 may present the redeemable offer notification to the user via display 118. For example, application 122 may present the redeemable offer when activated, may present the redeemable offer notification as a push notification to computing device 110, or in any other manner. In some aspects, the digital redeemable offer may be stored or saved in memory 114 of computing device 110 as redeemable offer data 124 by application 122. In some aspects, the digital redeemable offer may be stored or saved in memory 154 of server 150 as redeemable offer data 156. In some aspects, for example, the user may have a user account on server 150 and the stored redeemable offer data 156 may be associated with the user's user account.

In some aspects, the received redeemable offer notification may be a targeted redeemable offer notification that is tailored specifically for the user. In some aspects, for example, such a targeted redeemable offer notification may not be presented to other members of the general public.

At 304, application 122 receives user input that indicates a selection of a target venue through activation of element 204 (FIG. 2) using, for example, input device 120.

At 306, application 122 receives a request via user input, which activates element 208 (FIG. 8) of application 122. Responsive to activation, element 208 (FIG. 8) generates a recommended list of days and corresponding combinations of redeemable offers for the selected target venue, for example, using input device 120.

At 308, application 122 gathers redeemable offers for the selected target venue. For example, application 122 may gather redeemable offers from promotion data 124 residing on computing device 110 such as, for example, redeemable offer data generated by the user (e.g., through scanning of redeemable offers) or digitally received by the user (e.g., via e-mail or other digital sources). Application 122 may also gather redeemable offers from redeemable offer data 156 residing on server 150, e.g., redeemable offer data 156 that corresponds to the user or the user's user account. In some aspects, application 122 may also gather redeemable offers directly from venue 170, e.g., any web sites, social media or other digital source of redeemable offers associated with the venue, in the form of redeemable offer data 176. In some aspects, some or all of the redeemable offers may be redeemable offers that are individually targeted at the user where, for example, the general public does not have access to all of the same redeemable offers that the user does. Application 122 may receive the redeemable offers or redeemable offer data 156 and 176 from server 150 and venue 170 via network interfaces 116, 156, and 176. For example, application 122 may transmit a request for redeemable offer data 156 to server 150 via network interfaces 116 and 156 and a request for redeemable offer data to venue 170 via network interfaces 116 and 176. Application 122 may also receive the requested redeemable offer data 156 from server 150 via network interfaces 116 and 156 and receive the requested redeemable offer data 176 from venue 170 via network interfaces 116 and 176.

In some aspects, gathering redeemable offer data may also include determining whether the user has a rewards or credit card associated with the venue and determining whether there are any special redeemable offers associated with having or using such a rewards or credit card for a purchase.

At 310, application 122 analyzes the redeemable offers found in redeemable offer data 126, redeemable offer data 156, and redeemable offer data 176 to identify redeemable offers that correspond to the selected target venue. For example, application 122 may analyze redeemable offer data 126, redeemable offer data 156, and redeemable offer data 176 to identify coupons, awards, special codes, rebates, credit card related offers, or any other redeemable offer for the user that is associated with the selected target venue.

At 312, application 122 determines the event calendar days associated with each of the identified redeemable offers. For example, application 122 may determine that a redeemable offer of 20% off all store items may be available from Monday to Wednesday in the next week while a redeemable offer of $25 off when you spend $100 may be available from Wednesday to Friday next week.

At 314, application 122 receives calendar data 126 for the user, e.g., from memory 114. Calendar data 126 may include personal, business, or any other calendar information about the user. For example, calendar data 126 may include personal or business appointments, meetings, or other scheduled events that the user scheduled to attend. In some aspects, calendar data 126 may be retrieved from a calendar application such residing on computing device 110 or from a calendar associated with the user on the internet, server 150, or any other source. Application 122 may determine based on the calendar data 126 which calendar days the user is available to shop for products from the selected target venue.

At 316, application 122 compares the determined event calendar days to the calendar days that the determined available calendar days of the user.

At 318, application 122 determines whether any event calendar days match the determined available calendar days of the user. If no event calendar days match the determined available calendar days, application 122 ends processing of the recommendation list and informs the user that no recommended optimal shopping days have been found at 320, for example via display 118 and GUI 200.

At 322, if any event calendar days match the available calendar days of the user, application 122 generates a list of the matching calendar days.

At 324, application 122 determines which redeemable offers are available for each calendar day listed in the list of matching calendar days.

At 326, application 122 determines which calendar days from the list of matching calendar days have an optimal combination of redeemable offers and orders the list of matching calendar days based on the determined optimal combinations. For example, application 122 may order the list of matching calendar days based on a determined value or buying power of the redeemable offers for a given calendar day such as, e.g., overall discount, single item discount, value of rewards or rebates, gift cards, door buster sales, store dollars, or other similar criteria. For example, the calendar day having redeemable offers with the most value or buying power may be presented higher on the list than those calendar days that have redeemable offers with less buying power or a lower value. As an example, a matching calendar day that has corresponding redeemable offers of 20% off and $25 dollars off when you spend $100 dollars may be ordered higher on the list than a matching calendar day that has only one of the redeemable offers. In another example, a matching calendar that has corresponding redeemable offers of 20% off and $25 dollars off when you spend $100 dollars may be ordered lower on the list than a matching calendar day having 30% off since 30% off provides a greater value than both the 20% off offer and the $25 dollars off when you spend $100 offer (25% off). In some aspects, where both the 20% off and $25 dollars off when you spend $100 offers may be combined, the matching calendar day including both of these offers may be listed higher than a single 30% offer.

At 328, application 122 presents to the user via display 118 the ordered list of matching calendar days and the corresponding combinations of redeemable offers for each calendar day in the list. In some aspects, application 122 may also add the matching calendar days to the user's calendar as appointments.

At 330, application 122 generates a single bar code for the combined redeemable offers. For example, the user may only need to scan a single bar code to obtain the benefits of every redeemable offer that is active on a particular matching calendar day. For example, the generated single bar code may be associated with each of the promotions for a given matching calendar day in the venue's computer system. In some aspects, application 122 may generate a separate bar code for the combined redeemable offers of each matching calendar day, e.g., the user may be presented with a bar code corresponding to each calendar day that may be used to apply the redeemable offers for that calendar day. For example, if the shopper has availability on Tuesday afternoon after 1:00 and Thursday morning between 10:00 and 12:00 noon, computing device 110 or server 150 may determine the best combination of redeemable offers from all available redeemable offers for the user. Application 122 may present the user with a single bar code that “summarizes” or combines the best combination of redeemable offers for the user for each calendar day and time. The user may use the presented single bar code instead of scanning each coupon, discount voucher, etc. separately to apply the redeemable offers at checkout. For example, application 122 may present the user with a single bar code for Tuesday and a single bar code for Thursday where each single bar code is usable to apply the best combination of redeemable offers for that calendar day at checkout. In some aspects, application 122 may also or alternatively generate a separate bar code for each individual redeemable offer for a calendar day.

In some aspects, for example, the single bar code may be generated by application 122 may be transmitted or submitted to venue 170 or server 150 for use in future redeemable offers. For example, new redeemable offers notifications may be transmitted by venue 170 to other users associated with venue 170, e.g., via e-mail, push notifications, application 122 on computing devices associated with the other users, etc., including a list of redeemable offers covered by the single bar code. In some aspects, for example venue 170 may collate or collect all offers for their products for a given day into a single bar code for transmission to computing devices of users associated with venue 170 (e.g., users signed up to a mailing list, utilizing application 122 of the venue, visiting the venue's web site, etc.). In some aspects, each user may receive a single bar code tailored specifically for that user including at least some customized redeemable offers that may only be available to that user or to a select group of users.

The use of a single bar code as described above provides system 100 with increased efficiency by reducing the volume of messages needed to transmit redeemable offers to a user, e.g., between venue 170, server 150 and computing device 110, and reducing the network/bandwidth consumption of each individual message by removing the need to provide a separate bar code for each redeemable offer in the message, thereby reducing the message size.

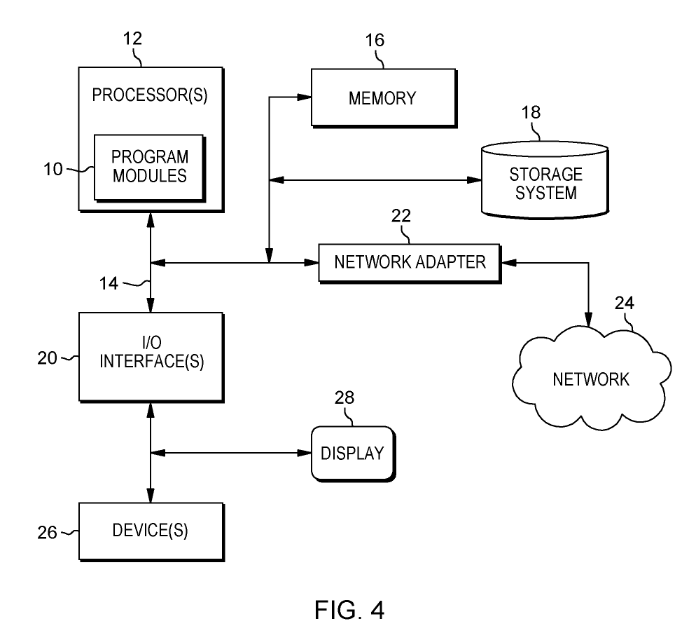

FIG. 4 illustrates a schematic of an example computer or processing system that may implement any portion of system 100, computing device 110, server 150, venue 170, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a software module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method implemented by at least one hardware processor comprising:
receiving, via an input device associated with a computing device of a user, a selection of a target venue by the user;
receiving notification data associated with the target venue, the notification data comprising a plurality of redeemable offers of the venue that are available to the user;
determining, based on the notification data, event calendar days during which the redeemable offers are active;
receiving calendar data associated with the user, the calendar data comprising at least one period of time in which the user is available to use redeemable offers;
comparing the determined event calendar days to the at least one period of time in which the user is available to use redeemable offers;
determining, based on the comparison, a list of calendar days during which the user is available to use redeemable offers and at least one of the redeemable offers is active;
determining an order for the list of calendar days based on the redeemable offers that are active for each calendar day in the list; and
presenting the ordered list of calendar days to the user via a display of the computing device.

2. The method of claim 1, wherein:
a first of the calendar days in the list that has a larger number of active redeemable offers than a second of the calendar days in the list; and
determining the ordering of the list of calendar days comprises ordering the first of the calendar days in the list higher on the list than the second of the calendar days in the list based on the number of active redeemable offers.

3. The method of claim 1, wherein:
a first of the calendar days in the list has active redeemable offers that provide a larger discount than the active redeemable offers of a second of the calendar days in the list; and
determining the ordering of the list of calendar days comprises ordering the first of the calendar days in the list higher on the list than the second of the calendar days in the list based on the discount.

4. The method of claim 1, wherein:
a first of the calendar days in the list has active redeemable offers that when combined together provide a higher discount than a discount provided by a combination of the active redeemable offers of a second of the calendar days in the list; and
determining the ordering of the list of calendar days comprises ordering the first of the calendar days in the list higher on the list than the second of the calendar days in the list based on the combined discount.

5. The method of claim 1, wherein receiving notification data associated with the target venue comprises receiving redeemable offers that are usable only by the user.

6. The method of claim 1, further comprising adding the calendar days in the list to the calendar data as appointments.

7. The method of claim 1, further comprising generating a single bar code that may be used by the user to apply the active redeemable offers for a given calendar day in the list.

8. A system comprising:
a display;
an input device; and
at least one hardware processor associated with the display and input device and configured to:
receive, via the input device, a selection of a target venue by a user;
receive notification data associated with the target venue, the notification data comprising a plurality of redeemable offers of the venue that are available to the user;
determine, based on the notification data, event calendar days during which the redeemable offers are active;
receive calendar data associated with the user, the calendar data comprising at least one period of time in which the user is available to use redeemable offers;
compare the determined event calendar days of the redeemable offers to the at least one period of time in which the user is available to use redeemable offers;
determine, based on the comparison, a list of calendar days during which the user is available to use redeemable offers and at least one of the redeemable offers is active;
determine an order for the list of calendar days based on the redeemable offers that are active for each calendar day in the list; and
present the ordered list of calendar days to the user via the display.

9. The system of claim 8, wherein:
a first of the calendar days in the list that has a larger number of active redeemable offers than a second of the calendar days in the list; and
determining the ordering of the list of calendar days comprises ordering the first of the calendar days in the list higher on the second of the calendar days in the list based on the number of active redeemable offers.

10. The system of claim 8, wherein:
a first of the calendar days in the list has active redeemable offers that provide a larger discount than the active redeemable offers of a second of the calendar days in the list; and
determining the ordering of the list of calendar days comprises ordering the first of the calendar days in the list higher on list than the second of the calendar days in the list based on the discount.

11. The system of claim 8, wherein:
a first of the calendar days in the list has active redeemable offers that when combined together provide a higher discount than a discount provided by a combination of the active redeemable offers of a second of the calendar days in the list; and
determining the ordering of the list of calendar days comprises ordering the first of the calendar days in the list higher on the list than the second of the calendar days in the list based on the combined discount.

12. The system of claim 8, wherein receiving notification data associated with the target venue comprises receiving redeemable offers that are usable only by the user.

13. The system of claim 8, the at least one hardware processor further configured to add the calendar days in the list to the calendar data as appointments.

14. The system of claim 8, the at least one hardware processor further configured to generate a single bar code that may be used by the user to apply the active redeemable offers for a given calendar day in the list.

15. A non-transitory computer readable medium comprising instructions that, when executed by at least one hardware processor, configure the at least one hardware processor to:
receive, via an input device associated with the at least one hardware processor, a selection of a target venue by a user;
receive notification data associated with the target venue, the notification data comprising a plurality of redeemable offers of the venue that are available to the user;
determine, based on the notification data, event calendar days during which the redeemable offers are active;
receive calendar data associated with the user, the calendar data comprising at least one period of time in which the user is available to use redeemable offers;
compare the determined event calendar days of the redeemable offers to the at least one period of time in which the user is available to use redeemable offers;
determine, based on the comparison, a list of calendar days during which the user is available to use redeemable offers and at least one of the redeemable offers is active;
determine an order for the list of calendar days in the list based on the redeemable offers that are active for each calendar day in the list; and
present the ordered list of calendar days to the user via a display associated with the at least one processor.

16. The non-transitory computer readable medium of claim 15, wherein:
a first of the calendar days in the list that has a larger number of active redeemable offers than a second of the calendar days in the list; and
determining the ordering of the list of calendar days comprises ordering the first of the calendar days in the list higher on the second of the calendar days in the list based on the number of active redeemable offers.

17. The non-transitory computer readable medium of claim 15, wherein:
a first of the calendar days in the list has active redeemable offers that provide a larger discount than the active redeemable offers of a second of the calendar days in the list; and
determining the ordering of the list of calendar days comprises ordering the first of the calendar days in the list higher on list than the second of the calendar days in the list based on the discount.

18. The non-transitory computer readable medium of claim 15, wherein:
a first of the calendar days in the list has active redeemable offers that when combined together provide a higher discount than a discount provided by a combination of the active redeemable offers of a second of the calendar days in the list; and
determining the ordering of the list of calendar days comprises ordering the first of the calendar days in the list higher on the list than the second of the calendar days in the list based on the combined discount.

19. The non-transitory computer readable medium of claim 15, the instructions further configuring the at least one hardware processor to add the calendar days in the list to the calendar data as appointments.

20. The non-transitory computer readable medium of claim 15, the instructions further configuring the at least one hardware processor to generate a single bar code that may be used by the user to apply the active redeemable offers for a given calendar day in the list.
